(19) United States
(12) Patent Application Publication
(10) Pub. No.: US 2024/0167417 A1
(43) Pub. Date: May 23, 2024

(54) POWER GENERATION SYSTEM, METHOD FOR DYNAMICALLY ADJUSTING A POWER GENERATION SYSTEM, AND METHOD FOR CONTROLLING A POWER GENERATION SYSTEM

(71) Applicant: MARVEL-TECH LTD., Shanghai (CN)

(72) Inventors: Gang LIN, Shanghai (CN); Yifeng CHEN, Shanghai (CN); Qing XU, Shanghai (CN)

(21) Appl. No.: 18/551,369

(22) PCT Filed: Nov. 28, 2022
(86) PCT No.: PCT/CN2022/134665

§ 371 Date: Sep. 19, 2023

(30) Foreign Application Priority Data
Nov. 30, 2021 (CN) 202111448492.7
Nov. 30, 2021 (CN) 202111448506.5

(51) Int. Cl. F02C 3/22; F02C 7/224

(52) U.S. Cl. CPC F02C 3/22; F02C 7/224; F05D 2220/60; F05D 2240/35

(57) ABSTRACT

By arranging a liquid ammonia supply portion, a gasification portion, an ammonia decomposition portion, a hydrogen storage portion, and a gas-turbine power generation set connected in sequence, the liquid ammonia outputted by the liquid ammonia supply portion is gasified in the gasification portion to form gaseous ammonia. The gaseous ammonia is delivered to the ammonia decomposition portion and decomposed into a hydrogen-mixed gas containing hydrogen, nitrogen and gaseous ammonia. The hydrogen-mixed gas is stored in the hydrogen storage portion. The hydrogen storage portion stably outputs the hydrogen-mixed gas to the gas-turbine power generation set. The gas-turbine power generation set uses hydrogen as a fuel, and hydrogen is obtained by ammonia decomposition. The power generation system uses liquid ammonia as a fuel supply. The gas-turbine power generation set can simultaneously combust and utilize the ammonia that has not been completely decomposed to generate no “carbon”.

### BACKGROUND OF THE INVENTION

### Field of the Invention

The present invention relates to a technical field for hydrogen generation by ammonia decomposition, particularly to a power generation system, a method for dynamically adjusting a power generation system, and a method for controlling a power generation system.

### Description of the Related Art

Under the requirements of the peaking of carbon emissions and carbon neutrality, reducing carbon dioxide emissions has become a topic, aiming at reducing the consumption of fossil fuels and finding energy sources that replace fossil fuels. Since ammonia and hydrogen are carbon-free, i.e. they do not produce carbon dioxide when combusted, they are of great interest in reducing carbon emissions. However, hydrogen is difficult to store and transport. Thus, it is difficult to use it as a fuel for power generation. Ammonia has established storage and transportation technology. Thus, it is expected to become a carrier of energy in the future. However, ammonia is not easy to combust in the air. When combusting, the flame spreads slowly and is easy to extinguish. As a result, it is difficult to directly use ammonia as a fuel for power generation systems.

### SUMMARY OF THE INVENTION

The technical problem to be solved by the present invention is to provide a power generation system, a method for dynamically adjusting a power generation system, and a method for controlling a power generation system, so as to solve the problem that the existing power generation system cannot directly use ammonia as a fuel for power generation.

In order to solve the foregoing problems, the technical solution of the present invention is described as follows:

A power generation system based on hydrogen production by ammonia decomposition of the present invention includes:

a liquid ammonia supply portion;

a gasification portion with an input thereof connected with the liquid ammonia supply portion for gasifying liquid ammonia into gaseous ammonia;

an ammonia decomposition portion with an input thereof connected with an output of the gasification portion for decomposing gaseous ammonia into a hydrogen-mixed gas containing hydrogen, nitrogen and gaseous ammonia;

a hydrogen storage portion with an input thereof connected with an output of the ammonia decomposition portion for storing and stably outputting the hydrogen-mixed gas;

a gas-turbine power generation set with a fuel input thereof connected with an output of the hydrogen storage portion for combusting the hydrogen-mixed gas to generate power;

in a power generation state, liquid ammonia outputted by the liquid ammonia supply portion is gasified into gaseous ammonia by the gasification portion and outputted to the ammonia decomposition portion, the ammonia decomposition portion decomposes the gaseous ammonia into a hydrogen-mixed gas containing hydrogen, nitrogen and gaseous ammonia, the hydrogen-mixed gas is outputted to the hydrogen storage portion for storage, and the hydrogen storage portion outputs the hydrogen-mixed gas to the gas-turbine power generation set for combustion and power generation. When the amount of hydrogen-mixed gas produced by the ammonia decomposition portion is greater than the combustion amount of hydrogen-mixed gas of the gas-turbine power generation set, excess hydrogen-mixed gas is temporarily stored in the hydrogen storage portion, and the liquid ammonia output flow of the liquid ammonia supply portion is reduced to balance supply and demand.

When the amount of hydrogen-mixed gas produced by the ammonia decomposition portion is less than the combustion amount of hydrogen-mixed gas of the gas-turbine power generation set, hydrogen-mixed gas temporarily stored in the hydrogen storage portion is a supplement to the amount of hydrogen-mixed gas delivered to the gas turbine, and the liquid ammonia output flow of the liquid ammonia supply portion is increased to balance supply and demand.

In the power generation system based on hydrogen production by ammonia decomposition of the present invention, the hydrogen storage portion includes a hydrogen storage surge tank and a compressor.

The input of the hydrogen storage surge tank is connected with the output of the ammonia decomposition portion through a hydrogen-mixed gas pipeline. The output of the hydrogen storage surge tank is connected with the fuel input of the gas-turbine power generation set for stabilizing the output pressure of the hydrogen-mixed gas.

The compressor is arranged on the hydrogen-mixed gas pipeline.

In the power generation system based on hydrogen production by ammonia decomposition of the present invention, the exhaust end of the gas-turbine power generation set is connected with the heat-source input of the ammonia decomposition portion, so that the gas-turbine exhaust gas provides a heat source for ammonia decomposition.

The power generation system based on hydrogen production by ammonia decomposition of the present invention further includes a heat regenerator.

The heat-source output of the ammonia decomposition portion is connected with the heat-source input of the heat regenerator. The compressed-air output of the heat regenerator is connected with the compressed-air input of the gas-turbine power generation set for preheating compressed air for the gas-turbine power generation set.

The power generation system based on hydrogen production by ammonia decomposition of the present invention further includes a supplementary combustion device.

The fuel input of the supplementary combustion device is connected with the output of the hydrogen storage portion. The heat-source output of the supplementary combustion device is connected with the heat-source input of the ammonia decomposition portion.

In the power generation system based on hydrogen production by ammonia decomposition of the present invention, the gasification portion includes a gasifier and a medium circulation pipeline.

The two ends of the gasifier are respectively connected with the output of the liquid ammonia supply portion and the input of the ammonia decomposition portion.

The medium circulation pipeline is coupled with the gas-turbine exhaust gas of the gas-turbine power generation set for heat exchange through a circulating medium heat exchanger. The head and tail ends of the medium circulation pipeline are respectively connected with the medium input and the medium output of the gasifier for heating liquid ammonia in a water bath.

In the power generation system based on hydrogen production by ammonia decomposition of the present invention, the medium circulation pipeline includes a water tank, a pump, a temperature control valve, and an input pipeline, an intermediate pipeline and an output pipeline sequentially connected.

The input of the input pipeline is connected with the medium output of the gasifier.

The output of the output pipeline is connected with the medium input of the gasifier.

The water tank and the pump are arranged on the input pipeline.

The temperature control valve is arranged between the intermediate pipeline and the output pipeline.

Wherein, the intermediate pipeline and the hydrogen-mixed gas produced by the ammonia decomposition device are coupled to exchange heat through a hydrogen-mixed gas cooling heat exchanger for absorbing heat of the hydrogen-mixed gas. The output of the intermediate pipeline is connected and coupled with the temperature control valve for heat exchange through the circulating medium heat exchanger and/or the output of the intermediate pipeline is directly connected with the temperature control valve.

In the power generation system based on hydrogen production by ammonia decomposition of the present invention, the circulating medium in the circulating medium pipeline is water or water/glycol mixed liquid.

In the power generation system based on hydrogen production by ammonia decomposition of the present invention, the ammonia decomposition portion includes a gaseous ammonia pipeline, a hydrogen-mixed gas pipeline, an ammonia decomposition device, and a gaseous ammonia preheating heat exchanger.

The two ends of the gaseous ammonia pipeline are respectively connected with the output of the gasification portion and the gaseous ammonia input of the ammonia decomposition device.

The two ends of the hydrogen-mixed gas pipeline are respectively connected with the hydrogen-mixed gas output of the ammonia decomposition device and the input of the hydrogen storage portion.

Wherein, the gaseous ammonia pipeline is connected with the cold end of the gaseous ammonia preheating heat exchanger, and the hydrogen-mixed gas pipeline is connected with the hot end of the gaseous ammonia preheating heat exchanger.

In the power generation system based on hydrogen production by ammonia decomposition of the present invention, the ammonia decomposition portion further includes a hydrogen-mixed gas cooling heat exchanger.

The hydrogen-mixed gas pipeline is connected with the hot end of the hydrogen-mixed gas cooling heat exchanger.

The cold end of the hydrogen-mixed gas cooling heat exchanger is connected with the medium circulation pipeline of the gasification portion.

Wherein, the hydrogen-mixed gas cooling heat exchanger is located on the downstream of the gaseous ammonia preheating heat exchanger.

In the power generation system based on hydrogen production by ammonia decomposition of the present invention,

In the power generation system based on hydrogen production by ammonia decomposition of the present invention, the gaseous ammonia pipeline is provided with a gaseous ammonia pressure regulating valve.

In the power generation system based on hydrogen production by ammonia decomposition of the present invention, a liquid ammonia flow valve is arranged on a pipeline connecting the liquid ammonia supply portion with the gasification portion.

In the power generation system based on hydrogen production by ammonia decomposition of the present invention, a hydrogen-mixed gas flow valve is arranged on a pipeline connecting the hydrogen storage portion with the gas turbine power generation set.

The power generation system based on hydrogen production by ammonia decomposition of the present invention further includes an electric heating portion with a heat-source output thereof connected to the gasification portion and/or the ammonia decomposition portion.

A method for dynamically adjusting a power generation system of the present invention is applied to one of the power generation systems based on hydrogen production by ammonia decomposition. The power generation system further includes a supplementary combustion device. The fuel input of the supplementary combustion device is connected with the output of the hydrogen storage portion. The heat-source output of the supplementary combustion device is connected with the heat-source input of the ammonia decomposition portion. The method includes:

according to the gas-turbine exhaust temperature of the gas-turbine power generation set and the supply amount of liquid ammonia, the amount of hydrogen-mixed gas entering the supplementary combustion device is adjusted to control and adjust the decomposition reaction temperature of the ammonia decomposition portion, so that ammonia entering the ammonia decomposition portion is effectively decomposed to produce the desired flow of the hydrogen-mixed gas.

A gas turbine-steam turbine combined power generation system based on hydrogen production by ammonia decomposition of the present invention includes:

a liquid ammonia supply portion;

a gasification portion with an input thereof connected with the liquid ammonia supply portion for gasifying liquid ammonia into gaseous ammonia;

an ammonia decomposition portion with an input thereof connected with the output of the gasification portion for decomposing gaseous ammonia into a hydrogen-mixed gas containing hydrogen, nitrogen and gaseous ammonia;

a gas-turbine power generation set with a fuel input thereof connected with the output of the ammonia decomposition portion for combusting the hydrogen-mixed gas to generate power;

a steam turbine portion;

a first steam extraction pipeline with an input thereof connected with the steam turbine portion, and the output of the first steam extraction pipeline is connected with the heat-source input of the gasification portion for extracting steam as a heat source in the steam turbine portion and sending out the heat source to the gasification portion;

in a power generation state, the liquid ammonia supply portion outputs liquid ammonia to the gasification portion, the first steam extraction pipeline extracts and outputs steam in the turbine portion to the gasification portion, and the steam gasifies the liquid ammonia in the gasification portion to form gaseous ammonia; the gaseous ammonia is outputted to the ammonia decomposition portion and decomposed into a hydrogen-mixed gas containing hydrogen, nitrogen and gaseous ammonia, and the hydrogen-mixed gas is outputted to the gas-turbine power generation set for combustion and power generation.

The gas turbine-steam turbine combined power generation system based on hydrogen production by ammonia decomposition of the present invention includes a boiler feed water device, a waste heat boiler, a steam-turbine power generation set, and a first water return pipeline.

The output end of the boiler feed water device is connected with the feed water input of the waste heat boiler.

The steam output of the waste heat boiler is connected with the steam input of the steam turbine generator set.

The condensed water output of the steam-turbine power generation set is connected with the input of the boiler feed water device.

The input of the first steam extraction pipeline is connected with the steam-turbine power generation set for extracting low-temperature steam.

The input of the first water return pipeline is connected with the condensed water output of the gasification portion, and the output of the first water return pipeline is connected with the input of the boiler feed water device.

The gas turbine-steam turbine combined power generation system based on hydrogen production by ammonia decomposition further includes a first steam exhaust pipeline and a second steam exhaust pipeline.

The input of the first steam exhaust pipeline is connected with the exhaust end of the gas-turbine power generation set. The output of the first steam exhaust pipeline is connected with the heat-source input of the ammonia decomposition portion for outputting the gas-turbine exhaust gas of the gas-turbine power generation set as a heat source to the ammonia decomposition portion.

The input of the second steam exhaust pipeline is connected with the heat-source output of the ammonia decomposition portion. The output of the second steam exhaust pipeline is connected with the exhaust input of the waste heat boiler for outputting gas-turbine exhaust gas utilized by the waste heat of the ammonia decomposition portion to the waste heat boiler for waste heat utilization.

The gas turbine-steam turbine combined power generation system based on hydrogen production by ammonia decomposition of the present invention further includes a supplementary combustion device. The fuel input of the supplementary combustion device is connected with the output of the ammonia decomposition portion. The heat-source output of the supplementary combustion device is connected with the heat-source input of the ammonia decomposition portion.

The gas turbine-steam turbine combined power generation system based on hydrogen production by ammonia decomposition of the present invention further includes a third steam exhaust pipeline. The input of the third steam exhaust pipeline is connected with the exhaust output of the waste heat boiler. The output of the third steam exhaust pipeline is used to connect to an external heating utilization system or an external cooling utilization system.

The gas turbine-steam turbine combined power generation system based on hydrogen production by ammonia decomposition of the present invention further includes a fourth steam exhaust pipeline with an input thereof connected with the exhaust end of the gas-turbine power generation set. The output of the fourth steam exhaust pipeline is connected with the exhaust input of the waste heat boiler for outputting the gas-turbine exhaust gas of the gas-turbine power generation set to the waste heat boiler for waste heat utilization.

The gas turbine-steam turbine combined power generation system based on hydrogen production by ammonia decomposition of the present invention further includes a second steam extraction pipeline and a first steam return pipeline.

The input of the second steam extraction pipeline is connected with the gas-turbine power generation set. The output of the second steam extraction pipeline is connected with the heat-source input of the ammonia decomposition portion for extracting and outputting the high-temperature steam of the gas-turbine power generation set as a heat source to the ammonia decomposition portion.

The input of the first steam return pipeline is connected with the heat-source output of the ammonia decomposition portion. The output of the first steam return pipeline is connected with the steam input of the gas-turbine power generation set for outputting steam utilized by the waste heat of the ammonia decomposition portion to the gas-turbine power generation set.

The gas turbine-steam turbine combined power generation system based on hydrogen production by ammonia decomposition of the present invention further includes a hydrogen storage portion arranged between the ammonia decomposition portion and the gas-turbine power generation set. The input and the output of the hydrogen storage portion are connected to the output of the ammonia decomposition portion and the fuel input of the gas-turbine power generation set respectively.

In the gas turbine-steam turbine combined power generation system based on hydrogen production by ammonia decomposition of the present invention, the hydrogen storage portion includes a hydrogen storage surge tank and a compressor.

The input of the hydrogen storage surge tank is connected with the output of the ammonia decomposition portion through a hydrogen-mixed gas pipeline. The output of the hydrogen storage surge tank is connected with the fuel input of the gas-turbine power generation set for stabilizing the output pressure of the hydrogen-mixed gas.

The compressor is arranged on the hydrogen-mixed gas pipeline.

In the gas turbine-steam turbine combined power generation system based on hydrogen production by ammonia decomposition of the present invention, the ammonia decomposition portion include a gaseous ammonia pipeline, a hydrogen-mixed gas pipeline, an ammonia decomposition device, and a gaseous ammonia preheating heat exchanger.

The two ends of the gaseous ammonia pipeline are respectively connected with the output of the gasification portion and the gaseous ammonia input of the ammonia decomposition device.

The two ends of the hydrogen-mixed gas pipeline are respectively connected with the hydrogen-mixed gas output of the ammonia decomposition device and the fuel input of the gas-turbine power generation set.

Wherein, the gaseous ammonia pipeline is connected with the cold end of the gaseous ammonia preheating heat exchanger. The hydrogen-mixed gas pipeline is connected with the hot end of the gaseous ammonia preheating heat exchanger.

In the gas turbine-steam turbine combined power generation system based on hydrogen production by ammonia decomposition of the present invention, the ammonia decomposition portion further includes a hydrogen-mixed gas cooling heat exchanger.

The hydrogen-mixed gas pipeline is connected with the hot end of the hydrogen-mixed gas cooling heat exchanger.

The cold end of the hydrogen-mixed gas cooling heat exchanger is connected with the first water return pipeline for cooling the hydrogen-mixed gas by the condensed water of the gasification portion.

Wherein, the hydrogen-mixed gas cooling heat exchanger is located on the downstream of the gaseous ammonia preheating heat exchanger.

In the gas turbine-steam turbine combined power generation system based on hydrogen production by ammonia decomposition of the present invention, the gaseous ammonia pipeline is provided with a gaseous ammonia pressure regulating valve.

In the gas turbine-steam turbine combined power generation system based on hydrogen production by ammonia decomposition of the present invention, a liquid ammonia flow valve is arranged on a pipeline connecting the liquid ammonia supply portion and the gasification portion.

In the gas turbine-steam turbine combined power generation system based on hydrogen production by ammonia decomposition of the present invention, a pipeline connecting the ammonia decomposition portion with the gas-turbine power generation set is provided with a hydrogen-mixed gas flow valve.

A control method of the present invention is applied to one of the gas turbine-steam turbine combined power generation systems based on hydrogen production by ammonia decomposition. The power generation system further includes a hydrogen storage portion arranged between the ammonia decomposition portion and the gas-turbine power generation set. The method includes:

When the amount of hydrogen-mixed gas produced by the ammonia decomposition portion is greater than the combustion amount of hydrogen-mixed gas of the gas-turbine power generation set, excess hydrogen-mixed gas is temporarily stored in the hydrogen storage portion, and the liquid ammonia output flow of the liquid ammonia supply portion is reduced to balance supply and demand;

When the amount of hydrogen-mixed gas produced by the ammonia decomposition portion is less than the combustion amount of hydrogen-mixed gas of the gas-turbine power generation set, hydrogen-mixed gas temporarily stored in the hydrogen storage portion is a supplement to the amount of hydrogen-mixed gas delivered to the gas turbine, and the liquid ammonia output flow of the liquid ammonia supply portion is increased to balance supply and demand.

In the control method of the present invention, the power generation system further includes a supplementary combustion device. The fuel input of the supplementary combustion device is connected with the output of the hydrogen storage portion. The heat-source output of the supplementary combustion device is connected with the heat-source input of the ammonia decomposition portion. The method includes:

according to the gas-turbine exhaust temperature of the gas-turbine power generation set and the supply amount of liquid ammonia, the amount of hydrogen-mixed gas entering the supplementary combustion device is adjusted to control and adjust the decomposition reaction temperature of the ammonia decomposition portion, so that ammonia entering the ammonia decomposition portion is effectively decomposed to produce the desired flow of the hydrogen-mixed gas.

Compared with the conventional technology, the present invention has the following advantages and positive effects due to the adoption of the foregoing technical scheme:

1. In an embodiment of the present invention, by arranging the liquid ammonia supply portion, the gasification portion, the ammonia decomposition portion, the hydrogen storage portion, and the gas-turbine power generation set connected in sequence, the liquid ammonia outputted by the liquid ammonia supply portion is gasified in the gasification portion to form gaseous ammonia. The gaseous ammonia is delivered to the ammonia decomposition portion and decomposed into a hydrogen-mixed gas containing hydrogen, nitrogen and a small amount of gaseous ammonia. The hydrogen-mixed gas is stored in the hydrogen storage portion. The hydrogen storage portion stably outputs the hydrogen-mixed gas to the gas-turbine power generation set. The gas-turbine power generation set uses hydrogen as fuel, and hydrogen is obtained by decomposing ammonia. The power generation system uses liquid ammonia as fuel supply. The gas-turbine power generation set can simultaneously combust and utilize the ammonia that has not been completely decomposed to generate no “carbon”. There is no need to purify hydrogen. The power generation system has a low cost, high safety, and high adaptability.

2. In an embodiment of the present invention, by arranging the hydrogen storage portion, it can be used as a storage device for pre-storing hydrogen when the power generation system is started. At the same time, due to the instability of the hydrogen-mixed gas produced by ammonia decomposition, the hydrogen storage portion can stabilize the pressure of the hydrogen-mixed gas. When too much hydrogen-mixed gas produced by the ammonia decomposition portion cannot be fully used by the gas-turbine power generation set, the excess hydrogen-mixed gas can be stored. Similarly, when the hydrogen-mixed gas produced by the ammonia decomposition portion insufficiently provide the fuel required for the gas-turbine power generation set, it can be replenished for a short time by the hydrogen-mixed gas stored in the hydrogen storage portion.

3. In an embodiment of the present invention, the gas-turbine exhaust gas of the gas-turbine power generation set is guided to the ammonia decomposition portion to provide the required heat source for ammonia decomposition, which implements the reuse of waste heat in the gas-turbine exhaust gas and improves the energy utilization rate. The embodiment further arranges a heat regenerator, which guides the gas-turbine exhaust gas utilized in the ammonia decomposition portion to the heat regenerator. The heat regenerator preheats the compressed air of the gas-turbine power generation set to implement the utilization of heat regeneration and improve the power generation efficiency of the gas-turbine power generation set.

4. In an embodiment of the present invention, by arranging the supplementary combustion device between the hydrogen storage portion and the ammonia decomposition portion, the decomposition temperature in the ammonia decomposition portion can be further increased. The decomposition temperature in the ammonia decomposition portion is not limited to the temperature provided by the gas-turbine exhaust gas, so that the selection of catalysts is more diverse, and the ammonia decomposition rate can be improved. By controlling the supplementary combustion amount of the supplementary combustion device, the ammonia decomposition temperature can be effectively controlled in a relatively stable range, thereby making the ammonia decomposition more stable. At the same time, when the gas-turbine power generation set operates under variable working conditions (such as partial-load or no-load conditions), and the gas-turbine exhaust gas is too low to provide the temperature required for ammonia decomposition, the supplementary combustion device can increase the supplementary combustion amount, thereby increasing the decomposition temperature to the temperature required for the ammonia decomposition catalyst.

5. In an embodiment of the present invention, the gasification portion is divided into a gasifier and a medium circulation pipeline. A circulating medium heat exchanger is arranged on the medium circulation pipeline, such that the coupling heat exchange between the circulating medium and the gas-turbine exhaust gas is implemented. Thus, the waste heat of the gas-turbine exhaust gas can be further utilized to improve the energy utilization rate.

6. In an embodiment of the present invention, the medium circulation pipeline is divided into a water tank, a pump, a temperature control valve, and an input pipeline, an intermediate pipeline, and an output pipeline connected in sequence. A hydrogen-mixed gas cooling heat exchanger is arranged on the intermediate pipeline. The hydrogen-mixed gas cooling heat exchanger uses the waste heat in the hydrogen-mixed gas outputted from the ammonia decomposition portion to heat the circulating medium, and simultaneously cools the hydrogen-mixed gas before entering the hydrogen storage portion to implement the utilization of waste heat. After the circulating medium in the intermediate pipeline can exchange heat through the hydrogen-mixed gas cooling heat exchanger, the circulating medium is directly outputted to the temperature control valve. If the temperature is insufficient, the circulating medium can also absorb heat from the circulating medium heat exchanger to and then the circulating medium heat exchanger outputs the circulating medium to the temperature control valve. The temperature control valve controls the temperature of the circulating medium inputted to the output pipeline.

7. In an embodiment of the present invention, the ammonia decomposition portion is divided into a gaseous ammonia pipeline, a hydrogen-mixed gas pipeline, an ammonia decomposition device, and a gaseous ammonia preheating heat exchanger. The gaseous ammonia pipeline and the hydrogen-mixed gas pipeline are respectively used as the input and the output of the ammonia decomposition device. By arranging the gaseous ammonia preheating heat exchanger, the gaseous ammonia in the gaseous ammonia pipeline can couple the hydrogen-mixed gas in the hydrogen-mixed gas pipeline for heat exchange, absorb the heat in the hydrogen-mixed gas to preheat the gaseous ammonia, and improve the energy utilization rate.

8. In an embodiment of the present invention, by arranging a liquid ammonia flow valve, a gaseous ammonia pressure regulating valve and a hydrogen-mixed gas flow valve, the supply amount of liquid ammonia, the pressure of gaseous ammonia and the output amount of hydrogen-mixed gas are respectively controlled, thereby controlling the operating state of the power generation system.

9. In an embodiment of the present invention, an electric heating portion is arranged on the gasification portion and the ammonia decomposition portion. As a result, when the power generation system is started, the gasification and the ammonia decomposition process of liquid ammonia can reach the required temperature by electric heating to start the gas-turbine power generation set until the power generation system smoothly operates.

10. In another embodiment of the present invention, by sequentially arranging the liquid ammonia supply portion, the gasification portion, the ammonia decomposition portion, and the gas-turbine power generation set, the hydrogen production by ammonia decomposition can be implemented to obtain the hydrogen-mixed gas containing hydrogen, nitrogen, and gaseous ammonia, and to perform combustion power generation. The steam turbine portion and the first steam extraction pipeline are further arranged. The first steam extraction pipeline extracts the steam in the steam turbine portion and outputs it as a heat source to the gasification portion. The steam is used as a heat source for gasification of liquid ammonia in the gasification portion, thereby avoiding individually arranging heating equipment and solving the problem that the gasification device needs to be equipped with individual heating equipment in the existing hydrogen production by ammonia decomposition.

11. In another embodiment of the present invention, by arranging the steam turbine portion including a boiler feed water device, a waste heat boiler, a steam-turbine power generation set, and a first water return pipeline, the boiler feed water device provides water for the waste heat boiler to generate steam and output it to the steam-turbine power generation set for power generation. The first steam extraction pipeline extracts low-temperature steam from the steam-turbine power generation set (such as a middle-pressure cylinder or a low-pressure cylinder) and outputs it to the gasification portion to gasify liquid ammonia. The first water return pipeline is further arranged to deliver the condensed water formed during the gasification process back to the boiler feed water device to achieve circulation.

12. In another embodiment of the present invention, the first steam exhaust pipeline and the second steam exhaust pipeline are arranged. The first steam exhaust pipeline outputs the gas-turbine exhaust gas of the gas-turbine power generation set to the ammonia decomposition portion, which provides the heat source required for the ammonia decomposition reaction. The second steam exhaust pipeline outputs the gas-turbine exhaust gas utilized by waste heat of the ammonia decomposition portion to the exhaust input of the waste heat boiler, so that the waste heat boiler can perform secondary utilization on the waste heat of a part of the gas-turbine exhaust gas, thereby improving the energy utilization rate of the power generation system.

13. In the embodiment, the supplementary combustion device is further arranged. Thus, when the reaction temperature of the gas-turbine exhaust gas is insufficient, the supplementary combustion device combusts the hydrogen-mixed gas as a supplement, so as to ensure that the temperature of the ammonia decomposition reaction is within the optimal temperature range. The decomposition temperature of the ammonia decomposition reaction can be further increased, not limited to the temperature provided by the gas-turbine exhaust gas. Accordingly, the selection of catalysts is more diverse, and the ammonia decomposition rate can also be improved. By controlling the supplementary combustion amount of the supplementary combustion device, the ammonia decomposition temperature can be effectively controlled in a relatively stable range, thereby making the ammonia decomposition more stable. At the same time, when the gas-turbine power generation set operates under variable working conditions (such as partial-load or no-load conditions), and the gas-turbine exhaust gas is too low to provide the temperature required for ammonia decomposition, the supplementary combustion device can increase the supplementary combustion amount, thereby increasing the decomposition temperature to the temperature required for the ammonia decomposition catalyst.

14. In another embodiment of the present invention, the third steam exhaust pipeline is further arranged. The third steam exhaust pipeline outputs the gas-turbine exhaust gas that has passed through the waste heat boiler for secondary waste heat utilization to, for example, an external combined cycle power generation system, an external heating utilization system, or an external cooling utilization system, so as to further implement waste heat utilization and improve the energy utilization rate of the power generation system.

15. In another embodiment of the present invention, by arranging the fourth steam exhaust pipeline, the gas-turbine exhaust gas of the gas-turbine power generation set is outputted to the waste heat boiler for waste heat utilization. The second steam extraction pipeline and the first steam return pipeline are further arranged. The second steam extraction pipeline extracts high-temperature steam from the steam-turbine power generation set (such as the steam inlet of the steam turbine or the high-pressure cylinder) and outputs it to the ammonia decomposition portion to serve as a heat source for ammonia decomposition reaction. The first steam return pipeline delivers steam whose heat is cooled to a certain extent and used by the ammonia decomposition portion back to the steam-turbine power generation set (such as a high-pressure cylinder, a middle-pressure cylinder or a low-pressure cylinder) for further power generation and utilization. 1. Use high-temperature steam as a heat source and provide it to the ammonia decomposition portion. There is no need to arrange a heating device on the ammonia decomposition portion. 2. Deliver cooled steam whose heat is utilized back to the steam-turbine power generation set for further power generation, which improves the power generation efficiency of the power generation system.

16. In another embodiment of the present invention, the ammonia decomposition portion is divided into a gaseous ammonia pipeline, a hydrogen-mixed gas pipeline, an ammonia decomposition device, and a gaseous ammonia preheating heat exchanger. The gaseous ammonia pipeline and the hydrogen-mixed gas pipeline are respectively used as the input and the output of the ammonia decomposition device. By arranging the gaseous ammonia preheating heat exchanger, the gaseous ammonia in the gaseous ammonia pipeline can couple the hydrogen-mixed gas in the hydrogen-mixed gas pipeline for heat exchange, absorb the heat in the hydrogen-mixed gas to preheat the gaseous ammonia, and improve the energy utilization rate.

17. In another embodiment of the present invention, by arranging the hydrogen-mixed gas cooling heat exchanger, the cold end and the hot end of the hydrogen-mixed gas cooling heat exchanger are respectively connected with the first water return pipeline and the hydrogen-mixed gas pipeline. The condensed water formed in the gasification portion is used to cool the hydrogen-mixed gas formed by the ammonia decomposition reaction, so that there is no need to cool the hydrogen-mixed gas again.

18. In another embodiment of the present invention, by arranging a liquid ammonia flow valve, a gaseous ammonia pressure regulating valve and a hydrogen-mixed gas flow valve, the supply amount of liquid ammonia, the pressure of gaseous ammonia and the output amount of hydrogen-mixed gas are respectively controlled, thereby controlling the operating state of the power generation system.

### BRIEF DESCRIPTION OF THE DRAWINGS

FIG. 1 is a diagram schematically illustrating a power generation system based on hydrogen production by ammonia decomposition of the present invention;

FIG. 2 is a diagram schematically illustrating a gas turbine-steam turbine combined power generation system based on hydrogen production by ammonia decomposition according to an embodiment of the present invention;

FIG. 3 is a diagram schematically illustrating a gas turbine-steam turbine combined power generation system based on hydrogen production by ammonia decomposition according to another embodiment of the present invention.

Explanation of reference signs: 1: liquid ammonia supply portion; 2: gasifier; 3: gaseous ammonia preheating heat exchanger; 4: ammonia decomposition device; 5: hydrogen-mixed gas cooling heat exchanger; 6: compressor; 7: hydrogen storage surge tank; 8: gas turbine power generation set; 9: supplementary combustion device; 10: heat regeneration portion; 11: temperature control valve; 12: water tank; 13: pump; 14: liquid ammonia flow valve; 15: gaseous ammonia pressure regulating valve; 16: hydrogen-mixed gas flow valve; 17: circulating medium heat exchanger; 101: liquid ammonia supply portion; 102: gasification portion; 103: gaseous ammonia preheating heat exchanger; 104: ammonia decomposition device; 105 : hydrogen-mixed gas cooling heat exchanger; 106: compressor; 107: hydrogen storage surge tank; 108: gas-turbine power generation set; 109: supplementary combustion device; 110: waste heat boiler; 111: boiler feed water device; 112: steam-turbine power generation set ;113: water pump; 114: liquid ammonia flow valve; 115: gaseous ammonia pressure regulating valve; 116: hydrogen-mixed flow valve; 117: first steam extraction pipeline; 118: first water return pipeline; 119: first steam exhaust pipeline 120: second steam exhaust pipeline; 121: third steam exhaust pipeline; 122: fourth steam exhaust pipeline; 123: second steam extraction pipeline; 124: first steam return pipeline.

### DETAILED DESCRIPTION OF THE INVENTION

A power generation system, a method for dynamically adjusting a power generation system, and a method for controlling a power generation system of the present invention will be further described in detail below with reference to the accompanying drawings and specific embodiments. The advantages and features of the present invention will be apparent according to the following description and claims.

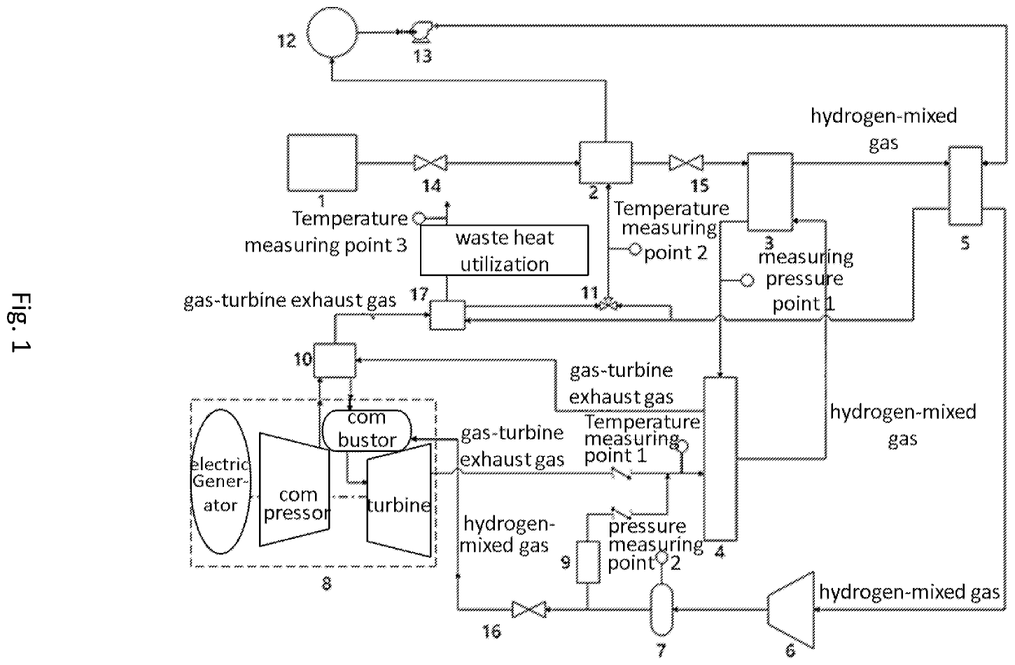

Referring to FIG. 1, in one embodiment, a power generation system based on hydrogen production by ammonia decomposition includes a liquid ammonia supply portion 1, a gasification portion, an ammonia decomposition portion, a hydrogen storage portion, and a gas-turbine power generation set 8.

Wherein, the liquid ammonia supply portion 1 may be specifically a liquid ammonia tank. The input of the gasification portion is connected with the liquid ammonia supply portion 1 for gasifying the liquid ammonia into gaseous ammonia. The input of the ammonia decomposition portion is connected with the output of the gasification portion for decomposing gaseous ammonia into a hydrogen-mixed gas containing hydrogen, nitrogen and a small amount of gaseous ammonia. The hydrogen-mixed gas can be used as a fuel for the gas-turbine power generation set 8. The ammonia decomposition portion can be used for different kinds of ammonia decomposition catalysts.

The input of the hydrogen storage portion is connected with the output of the ammonia decomposition portion for storing and stably outputting the foregoing hydrogen-mixed gas. The fuel input end of the gas-turbine power generation set 8 is connected with the output of the hydrogen storage portion for combusting the hydrogen-mixed gas to generate power.

In the embodiment, by arranging the liquid ammonia supply portion 1, the gasification portion, the ammonia decomposition portion, the hydrogen storage portion, and the gas-turbine power generation set 8 connected in sequence, the liquid ammonia outputted by the liquid ammonia supply portion 1 is gasified in the gasification portion to form gaseous ammonia. The gaseous ammonia is delivered to the ammonia decomposition portion and decomposed into a hydrogen-mixed gas containing hydrogen, nitrogen and a small amount of gaseous ammonia. The hydrogen-mixed gas is stored in the hydrogen storage portion. The hydrogen storage portion stably outputs the hydrogen-mixed gas to the gas-turbine power generation set 8. The gas-turbine power generation set 8 uses hydrogen as a fuel, and hydrogen is obtained by decomposing ammonia. The power generation system uses liquid ammonia as a fuel supply. The gas-turbine power generation set 8 can simultaneously combust and utilize ammonia that has not been completely decomposed to generate no “carbon”. There is no need to purify hydrogen. The power generation system has a low cost, high safety, and high adaptability.

In the embodiment, by arranging the hydrogen storage portion, it can be used as a storage device for pre-storing hydrogen when the power generation system is started. At the same time, due to the instability of the hydrogen-mixed gas produced by ammonia decomposition, the hydrogen storage portion can stabilize the pressure of the hydrogen-mixed gas. When too much hydrogen-mixed gas produced by the ammonia decomposition portion cannot be fully used by the gas-turbine power generation set 8, the excess hydrogen-mixed gas can be stored. Similarly, when the hydrogen-mixed gas produced by the ammonia decomposition portion insufficiently provide the fuel required for the gas-turbine power generation set 8, it can be replenished for a short time by the hydrogen-mixed gas stored in the hydrogen storage portion.

The specific structure of the power generation system based on hydrogen production by ammonia decomposition in the embodiment will be further described as follows:

In the embodiment, the hydrogen storage portion may specifically include a hydrogen storage surge tank 7 and a compressor 6, wherein the compressor 6 may be optional. If the gas pressure of the hydrogen-mixed gas entering the hydrogen storage surge tank 7 may be larger, the compressor 6 can be arranged to compress the hydrogen-mixed gas entering the hydrogen storage surge tank 7.

Specifically, the input of the hydrogen storage surge tank 7 is connected with the output of the ammonia decomposition portion through a hydrogen-mixed gas pipeline. The output of the hydrogen storage surge tank 7 is connected with the fuel input of the gas-turbine power generation set 8 for stabilizing the output pressure of the hydrogen-mixed gas. The compressor 6 is arranged on the hydrogen-mixed gas pipeline.

Wherein, the hydrogen storage surge tank 7 is arranged on a pipeline where the hydrogen-mixed gas is delivered to the gas-turbine power generation set 8, and used to store the hydrogen-mixed gas produced by ammonia decomposition and deliver the hydrogen-mixed gas to the gas-turbine power generation set 8. The gas in the hydrogen storage surge tank 7 has a certain pressure, which must be greater than the minimum pressure required for the gas-turbine power generation set 8 and less than the pressure of the hydrogen-mixed gas produced by ammonia decomposition or the pressure at the outlet of the compressor 6.

At the same time, the hydrogen storage surge tank also has the functions of temporarily storing the hydrogen-mixed gas and replenishing the hydrogen-mixed gas to the gas-turbine power generation set 8 for a short time. The temporary storage is explained as follows: After completely starting the gas-turbine power generation set 8, the gas and its pressure in the hydrogen storage surge tank 7 decrease. The hydrogen-mixed gas produced by ammonia decomposition firstly enters the hydrogen storage surge tank 7 for storage. Then, the hydrogen storage surge tank 7 provides the hydrogen-mixed gas for the gas-turbine power generation set 8. When the decomposition amount of ammonia exceeds the consumption of the gas-turbine power generation set 8, the excess hydrogen-mixed gas will be stored in the tank. The maximum pressure of the hydrogen-mixed gas stored and generated by ammonia decomposition or the pressure at the outlet of the compressor is less than or equal to the pressure in the tank. The short-term replenishment is explained as follows: If the decomposition amount of ammonia is lower than the consumption of the gas-turbine power generation set 8, the gas-turbine power generation set 8 can use the hydrogen-mixed gas stored in the hydrogen storage surge tank 7 for a short time until the pressure in the tank is lower than the pressure of the minimum hydrogen-mixed gas required for the gas-turbine power generation set 8.

In the embodiment, in order to improve the overall energy utilization rate of the power generation system, the exhaust end of the gas-turbine power generation set 8 can be connected with the heat-source input of the ammonia decomposition portion, so that the gas-turbine exhaust gas can provide a heat source for ammonia decomposition. The gas-turbine exhaust gas of the gas-turbine power generation set 8 is guided to the ammonia decomposition portion to provide the heat source required for ammonia decomposition, thereby implementing the reuse of waste heat in the gas-turbine exhaust gas and improving the energy utilization rate.

Further, the power generation system based on hydrogen production by ammonia decomposition in the embodiment can also be provided with a heat regenerator 10. The heat-source output of the ammonia decomposition portion is connected with the heat-source input of the heat regenerator 10. The compressed air output of the heat regenerator 10 is connected with the compressed air input of the gas-turbine power generation set 8 for preheating the compressed air of the gas-turbine power generation set 8 (that is, the gas-turbine exhaust gas entering the ammonia decomposition portion is delivered to the heat regenerator 10 to preheat the compressed air after utilizing the waste heat). The gas-turbine exhaust gas utilized in the ammonia decomposition portion is guided to the heat regenerator 10. The heat regenerator 10 preheats the compressed air entering the gas-turbine power generation set 8 to implement heat regeneration and improve the power generation efficiency of the gas-turbine power generation set 8.

Furthermore, there is still a certain amount of heat in the gas-turbine exhaust gas that has been reheated and utilized in the heat regenerator 10, and the heat can be outputted from the heat regenerator 10 to the outside for waste heat utilization (such as combined cycle power generation, heating utilization, cooling utilization, etc.).

In the embodiment, the power generation system based on hydrogen production by ammonia decomposition may further include a supplementary combustion device 9. The fuel input of the supplementary combustion device 9 is connected with the output of the hydrogen storage portion. The heat-source output of the supplementary combustion device 9 is connected with the heat-source input of the ammonia decomposition portion. The hydrogen-mixed gas in the hydrogen storage surge tank 7 is combusted to provide the reaction temperature required for the ammonia decomposition portion.

By arranging the supplementary combustion device 9 between the hydrogen storage portion and the ammonia decomposition portion 4, the decomposition temperature in the ammonia decomposition portion can be further increased. The decomposition temperature in the ammonia decomposition portion is not limited to the temperature provided by the gas-turbine exhaust gas, so that the selection of catalysts is more diverse, and the ammonia decomposition rate can be improved. By controlling the supplementary combustion amount of the supplementary combustion device 9, the ammonia decomposition temperature can be effectively controlled in a relatively stable range, thereby making the ammonia decomposition more stable. At the same time, when the gas-turbine power generation set 8 operates under variable working conditions (such as partial-load or no-load conditions), and the gas-turbine exhaust gas is too low to provide the temperature required for ammonia decomposition, the supplementary combustion device 9 can increase the supplementary combustion amount, thereby increasing the decomposition temperature to the temperature required for the ammonia decomposition catalyst.

In the embodiment, since liquid ammonia can be gasified by heating in a water bath, the gasification portion can specifically include a gasifier 2 and a medium circulation pipeline. The circulating medium in the medium circulation pipeline can be water or water/ethylene glycol mixed liquid.

Wherein, the two ends of the gasifier 2 are respectively connected with the output of the liquid ammonia supply portion 1 and the input of the ammonia decomposition portion. The medium circulation pipeline is coupled with the gas-turbine exhaust gas of the gas-turbine power generation set 8 for heat exchange through a circulation medium heat exchanger 17. The head and tail ends of the medium circulation pipeline are respectively connected with the medium input and the medium output of the gasifier 2, thereby heating liquid ammonia in a water bath. By arranging the circulating medium heat exchanger 17 on the medium circulation pipeline, the coupling heat exchange between the circulating medium and the gas-turbine exhaust gas can be implemented, so that the waste heat of the gas-turbine exhaust gas can be further utilized and the energy utilization rate can be improved. Wherein, the gas-turbine exhaust gas entering the circulating medium heat exchanger 17 can be directly drawn out from the ammonia decomposition device 4, or can be drawn out from the heat regenerator 10. (That is, for the waste heat utilization of the gas-turbine exhaust gas, after the gas-turbine exhaust gas is drawn out, the waste heat of the gas-turbine exhaust gas is utilized in the ammonia decomposition device 4, the heat regenerator 10, and the circulating medium heat exchanger 17. After finally passing through the circulating medium heat exchanger 17 to exchange heat, the gas-turbine exhaust gas still retains a certain amount of heat, which can be further extracted and used for combined cycle power generation, heating utilization or cooling utilization, etc.)

Specifically, the medium circulation pipeline may include a water tank 12, a pump 13, a temperature control valve 11, and an input pipeline, an intermediate pipeline and an output pipeline connected in sequence. The input of the input pipeline is connected with the medium output of the gasifier 2. The output of the output pipeline is connected with the medium input of the gasifier 2. The water tank 12 and the pump 13 are respectively arranged on the input pipeline. The temperature control valve 11 is arranged between the intermediate pipeline and the output pipeline.

Wherein, the intermediate pipeline and the hydrogen-mixed gas produced by the ammonia decomposition device 4 are coupled to exchange heat through a hydrogen-mixed gas cooling heat exchanger 5 for absorbing the heat of the hydrogen-mixed gas. The output of the intermediate pipeline is connected and coupled with the temperature control valve 11 for heat exchange through the circulating medium heat exchanger 17 and/or the output of the intermediate pipeline is directly connected with the temperature control valve 11.

In the embodiment, a hydrogen-mixed gas cooling heat exchanger 5 is arranged on the intermediate pipeline. The waste heat in the hydrogen-mixed gas is outputted from the ammonia decomposition portion and used to heat the circulating medium. At the same time, the hydrogen-mixed gas before entering the hydrogen storage portion is also cooled. The circulating medium in the intermediate pipeline can be directly outputted to the temperature control valve 11 after passing through the hydrogen-mixed gas cooling heat exchanger 5 to exchange heat and after being absorbed by the circulating medium heat exchanger 17. The temperature control valve 11 controls the temperature of the circulating medium inputted to the output pipeline.

In the embodiment, the ammonia decomposition portion may include a gaseous ammonia pipeline, a hydrogen-mixed gas pipeline, an ammonia decomposition device 4, and a gaseous ammonia preheating heat exchanger 3.

The two ends of the gaseous ammonia pipeline are respectively connected with the output of the gasification portion 2 and the gaseous ammonia input of the ammonia decomposition device 4. The two ends of the hydrogen-mixed gas pipeline are respectively connected with the hydrogen-mixed gas output of the ammonia decomposition device 4 and the input of the hydrogen storage portion. Wherein, the gaseous ammonia pipeline is connected with the cold end of the gaseous ammonia preheating heat exchanger 3. The hydrogen-mixed gas pipeline is connected with the hot end of the gaseous ammonia preheating heat exchanger 3.

In the embodiment, the gaseous ammonia preheating heat exchanger 3 is arranged, so that the gaseous ammonia in the gaseous ammonia pipeline can couple and exchange heat with the hydrogen-mixed gas in the hydrogen-mixed gas pipeline, and absorb the heat in the hydrogen-mixed gas to preheat the gaseous ammonia, thereby improving the energy utilization rate.

Further, the ammonia decomposition portion may also include the foregoing hydrogen-mixed gas cooling heat exchanger 5. The hydrogen-mixed gas pipeline is connected with the hot end of the hydrogen-mixed gas cooling heat exchanger 5. The cold end of the hydrogen-mixed gas cooling heat exchanger 5 is connected with the medium circulation pipeline of the gasification portion. Wherein, the hydrogen-mixed gas cooling heat exchanger 5 is located on the downstream of the gaseous ammonia preheating heat exchanger 3.

The hydrogen-mixed gas after the first heat exchange and the circulating medium in the circulation medium pipeline are coupled for heat exchange through the hydrogen-mixed gas cooling heat exchanger 5. On the one hand, it is to cool the hydrogen-mixed gas. On the other hand, the remaining heat in the hydrogen-mixed gas is delivered to the circulating medium for utilization.

In the embodiment, a gaseous ammonia pressure regulating valve 15 is arranged on the gaseous ammonia pipeline. A liquid ammonia flow valve 14 is arranged on a pipeline connecting the liquid ammonia supply portion 1 with the gasification portion. A hydrogen-mixed gas flow valve 16 is arranged on a pipeline connecting the hydrogen storage portion with the gas-turbine power generation set 8. In the embodiment, by arranging the liquid ammonia flow valve 14, the gaseous ammonia pressure regulating valve 15, and the hydrogen-mixed gas flow valve 16, the supply amount of liquid ammonia, the pressure of gaseous ammonia and the output amount of hydrogen-mixed gas are respectively controlled, thereby controlling the operating state of the power generation system.

In the embodiment, the power generation system based on hydrogen production by ammonia decomposition may also include an electric heating portion. The heat-source output of the electric heating portion is connected with the gasification portion and/or the ammonia decomposition portion. The electric heating portion is arranged on the gasification portion and the ammonia decomposition portion. Thus, when the power generation system is started, the gasification and the ammonia decomposition process of liquid ammonia can reach the required temperature by electric heating to start the gas-turbine power generation set 8 until the power generation system smoothly operates.

The principle of hydrogen production by ammonia decomposition in the embodiment will be described as follows:

The principle of hydrogen production by ammonia decomposition is that gaseous ammonia will be decomposed under the action of a catalyst at a certain temperature. That is to say, 2NH₃═N₂═3H₂. It can be seen that when the ammonia decomposition rate reaches 50%, the volume fraction of hydrogen in the mixture of hydrogen, nitrogen and gaseous ammonia is 50%. The higher the ammonia decomposition rate, the higher the content of hydrogen. Hydrogen easily ignites (e.g., the minimum ignition energy of 0.019 mJ), and has a wide flammable range (e.g., 4%˜75% compared to air volume). Hydrogen is ignited and combusted, and the combustion temperature of hydrogen is relatively high (generally higher than 1000° C.). The combustion temperature of hydrogen is much higher than the ignition point (i.e., 651.1° C.) of ammonia. Thus, ammonia will also be combusted. Accordingly, the gas-turbine power generation set 8 can directly combust the hydrogen-mixed gas.

However, the type of the catalyst in the hydrogen production process based on ammonia decomposition in the embodiment can also be selected according to the gas-turbine exhaust temperature or the temperature after supplementary combustion. The selected type of the catalyst can be adapted to low temperature and high temperature, such as Ru, Fe, Ni, etc. The ammonia decomposition rate can be improved by adjusting the catalyst or the reaction temperature (that is, increasing the gas-turbine exhaust temperature or the supplementary combustion amount).

The power generation system of the embodiment can be started in two methods:

1. Use hydrogen or hydrogen-mixed gas pre-stored in the hydrogen storage surge tank 7 as a fuel, start the gas-turbine power generation set 8, use the gas-turbine exhaust gas or supplementary combustion to gasify liquid ammonia, and decompose ammonia and produce hydrogen until the system reaches a stable operating state;

2. Gasify ammonia by electric heating, and decompose the ammonia to produce hydrogen by electric heating, and then start the gas-turbine power generation set 8 until the system reaches a stable operation state.

The process of the power generation system based on hydrogen production by ammonia decomposition in the embodiment will be further described as follows:

The power generation system based on hydrogen production by ammonia decomposition in the embodiment can be specifically divided into three subsystems, which include a gas-turbine power generation set 8 system, a hydrogen production system by ammonia decomposition, and a circulating water system.

The process of the gas-turbine power generation set 8 system:

The gas-turbine power generation set 8 combusts the hydrogen-mixed gas produced by ammonia decomposition to generate power and a gas-turbine exhaust gas with high temperature. The gas-turbine exhaust gas enters the ammonia decomposition device 4 to provide a heat source for ammonia decomposition. According to the design requirements of the gas turbine, the heat regenerator 10 can be designed for heat regeneration, thereby improving the power generation efficiency of the gas-turbine power generation set. The gas-turbine exhaust gas at the outlet of the heat regenerator 10 enters the circulating medium heat exchanger 17 to heat the circulating medium. The final exhaust gas of the gas turbine can also be used for waste heat (such as combined cycle power generation, heating utilization, cooling utilization, etc.).

The process of the hydrogen production system by ammonia decomposition:

Using the high pressure of liquid ammonia or a booster pump, the liquid ammonia is delivered to the gasifier 2 heated in a water bath to complete gasification. The gaseous ammonia after gasification is delivered to the ammonia decomposition device 4 after pressure regulation and is preheated by the hydrogen-mixed gas produced by ammonia decomposition in the gaseous ammonia preheating heat exchanger 3. The gaseous ammonia is decomposed and heated in the ammonia decomposition device 4 to produce a hydrogen-mixed gas composed of higher-temperature hydrogen, nitrogen and incompletely-decomposed gaseous ammonia. The hydrogen-mixed gas enters the gaseous ammonia preheating heat exchanger 3 to utilize the waste heat of the foregoing gaseous ammonia and enters the hydrogen-mixed gas cooling heat exchanger 5 to be cooled. The cooled hydrogen-mixed gas passes through the compressor 6 (determine whether it is configured according to the requirement of the gas turbine), and enters the hydrogen storage surge tank 7. The hydrogen-mixed gas at the outlet of hydrogen storage surge tank 7 is controlled and adjusted to enter the gas-turbine power generation set 8. Alternatively, the hydrogen-mixed gas at the outlet of hydrogen storage surge tank 7 enters the supplementary combustion device 9 according to the control requirements of the ammonia decomposition device 4.

The process of the circulating water system:

Water or water/ethylene glycol mixed liquid at a certain temperature is stored in a closed water tank 12 and delivered to the hydrogen-mixed gas cooling heat exchanger 5 by a pump 13. After water or the water/ethylene glycol mixed liquid cools the hydrogen-mixed gas produced by ammonia decomposition in the hydrogen-mixed gas cooling heat exchanger 5, water or the water/ethylene glycol mixed liquid enters the circulating medium heat exchanger 17 and the temperature control valve 11. After water or the water/ethylene glycol mixed liquid is heated by the waste heat of the gas-turbine exhaust gas in the circulating medium heat exchanger 17, the temperature control valve 11 controls the temperature of water or the water/ethylene glycol mixed liquid in a relatively stable range and then water or the water/ethylene glycol mixed liquid enters the gasifier 2. The temperature-stabilized water or water/ethylene glycol mixed liquid heats up the liquid ammonia and gasifies it. Afterwards, the temperature of the gasified ammonia drops significantly and the gasified ammonia enters the water tank 12 to form a closed loop.

### Embodiment 2

The embodiment provides a dynamic adjustment method, which is applied to the power generation system based on hydrogen production by ammonia decomposition in embodiment 1, and the specific method is introduced as follows:

When the amount of hydrogen-mixed gas produced by the ammonia decomposition device 4 is greater than the amount of hydrogen-mixed gas combusted by the gas-turbine power generation set 8, the excess hydrogen-mixed gas is temporarily stored in the hydrogen storage surge tank 7. At the same time, the liquid ammonia supply portion 1 delivers the liquid ammonia whose flow rate is reduced to enter the gasifier 2, so that the amount of hydrogen-mixed gas produced is reduced to balance with the combustion amount of hydrogen-mixed gas. This method can be specifically applied to a state where the gas-turbine power generation set 8 needs to reduce the power generation, such as partial-load or no-load states, etc.

When the amount of hydrogen-mixed gas produced by the ammonia decomposition device 4 is less than the combustion amount of hydrogen-mixed gas of the gas-turbine power generation set 8, the hydrogen-mixed gas temporarily stored in the hydrogen storage surge tank 7 is delivered to the gas-turbine power generation set for short-term replenishment. At the same time, the flow of liquid ammonia entering the gasifier 2 from the liquid ammonia supply portion 1 is increased, so that the amount of hydrogen-mixed gas produced increases and tends to balance with the combustion amount of hydrogen-mixed gas. This method can be specifically applied to a state where the gas-turbine power generation set 8 needs to increase the power generation, such as from a non-full-load state to a full-load state, etc.

Further, according to the real-time monitored gas-turbine exhaust temperature (temperature measuring point 1) of the gas-turbine power generation set 8 and the type of ammonia decomposition catalyst used, the amount of hydrogen-mixed gas entering the supplementary combustion device 9 can be adjusted so that the data of temperature measuring point 1 matches the temperature required for the selected ammonia decomposition catalyst. As a result, the decomposition reaction temperature of the ammonia decomposition device 4 is controlled and adjusted, so that the gaseous ammonia entering the ammonia decomposition device 4 can be effectively decomposed to produce the required flow of hydrogen-mixed gas. The inlet water temperature of the gasifier 2 (temperature measuring point 2) is monitored and controlled in real time, so that the temperature data is controlled at about 50˜70° C. and the liquid ammonia entering the gasifier 2 can be effectively gasified and maintained at a certain superheating state.

The Other Control Methods of the Power Generation System Based on Hydrogen Production by Ammonia Decomposition in the Foregoing Embodiment Will be Described as Follows

I. Control of the hydrogen-mixed gas entering the gas-turbine power generation set 8: The pressure of the hydrogen-mixed gas entering the gas-turbine power generation set 8 is set by the hydrogen storage surge tank 7. The flow of the hydrogen-mixed gas entering the gas-turbine power generation set 8 is adjusted and controlled by the hydrogen-mixed flow valve 16. The pressure (pressure measuring point 1) of ammonia entering the ammonia decomposition portion is monitored and controlled in real time, so that the pressure data is set to the pressure (such as 7 bar) corresponding to the requirement of the gas turbine or the inlet pressure of the appropriate hydrogen compressor.

II. Steady-state control of the hydrogen storage surge tank 7: 1) When the gas-turbine power generation set 8 starts or operates, the hydrogen-mixed gas in the hydrogen storage surge tank 7 is consumed, and the pressure in the tank will decrease. When the pressure in the tank drops to a certain value, the liquid ammonia flow valve 14 is interlocked and opened to control the flow of liquid ammonia according to the amount of the hydrogen-mixed gas required for the gas-turbine power generation set 8 in operation, so that the flow of the hydrogen-mixed gas produced by the ammonia decomposition device 4 meets the current requirement of the gas-turbine power generation set 8 in an operation state. The mixed gas pressure (pressure measuring point 2) of the hydrogen storage surge tank 7 is monitored and controlled in real time, so that the pressure data is controlled within a certain range (the outlet air pressure of the gas-turbine compressor+(˜2-10 bar)), and the high/low pressure alarm and interlock design at pressure measuring point 2 are set. When the pressure of pressure measuring point 2 is high, the compressor 6 and the liquid ammonia supply portion 1 stop working. When the pressure of pressure measuring point 2 is low, the liquid ammonia supply portion 1 and the compressor 6 start working.

2) When the amount of hydrogen-mixed gas produced by the ammonia decomposition device 4 is greater than the combustion amount of hydrogen-mixed gas of the gas-turbine power generation set 8, the excess hydrogen-mixed gas is temporarily stored in the hydrogen storage surge tank 7, the maximum pressure stored in the tank is equal to the pressure of the hydrogen-mixed gas in the ammonia decomposition device 4 or the compressed pressure of the compressor 6, and the flow is controlled by the liquid ammonia flow valve 14, so that supply and demand can reach a steady state balance.

3) When the amount of hydrogen-mixed gas produced by the ammonia decomposition device 4 is less than the combustion amount of hydrogen-mixed gas of the gas-turbine power generation set 8, the hydrogen-mixed gas temporarily stored in the hydrogen storage surge tank 7 is delivered to the gas-turbine power generation set 8 and used as a supplement to the amount of the hydrogen-mixed gas of the gas-turbine power generation set 8 until the pressure in the tank is equal to the minimum pressure of hydrogen-mixed gas required for the gas-turbine power generation set 8. The liquid ammonia flow valve 14 is opened and interlocked to control the flow of liquid ammonia according to the setting value of pressure in the tank, so that supply and demand reach a steady state balance.

4) Pressure setting of hydrogen storage surge tank 7: greater than the minimum requirement pressure and less than the maximum setting pressure in the tank.

### Embodiment 3

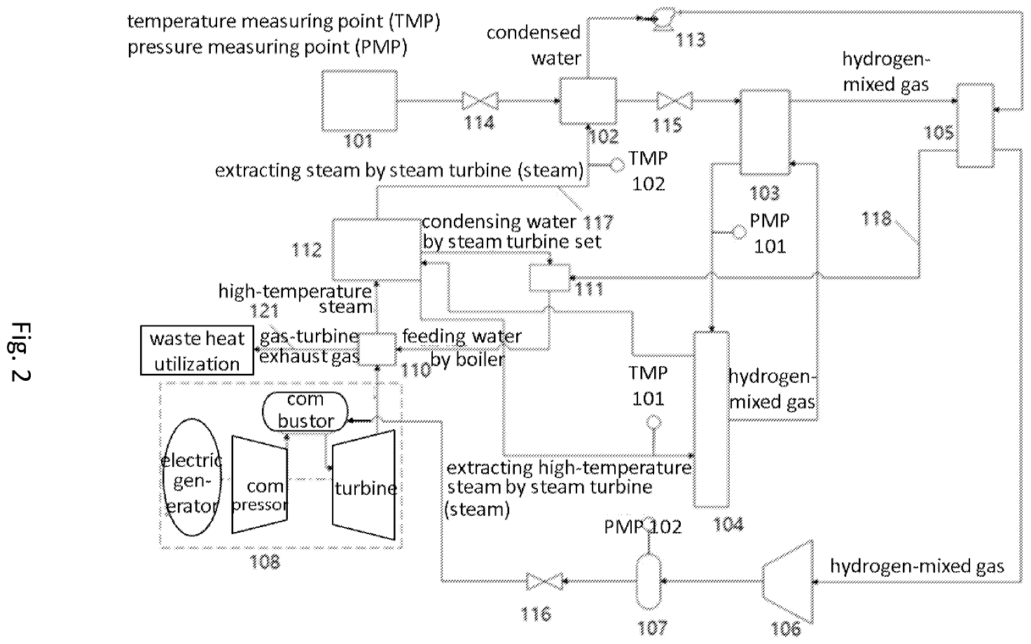

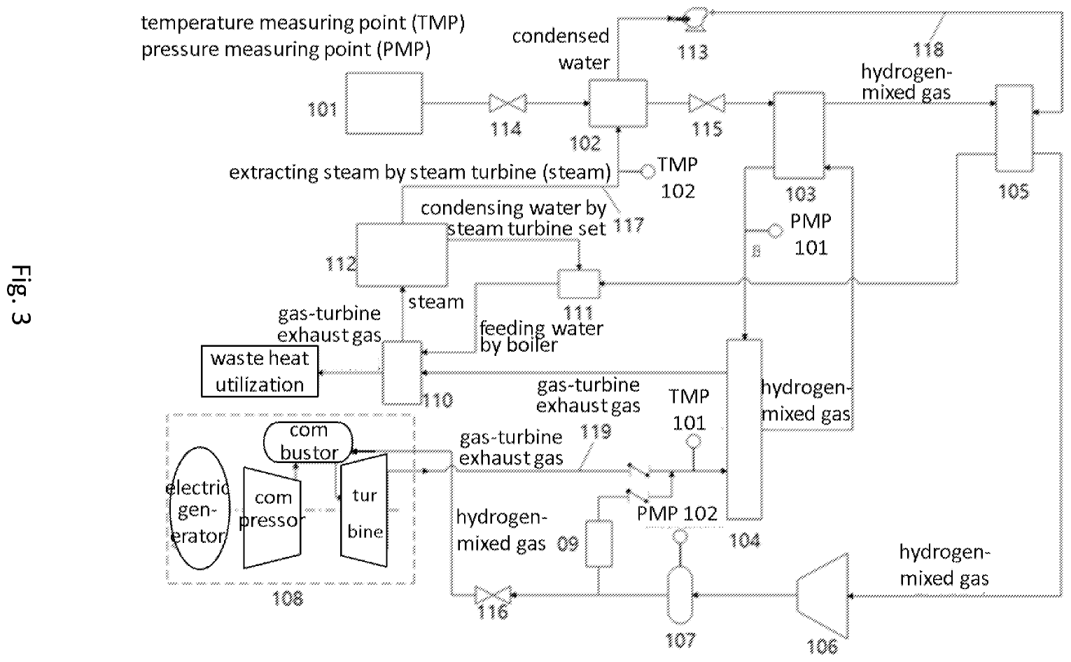

Referring to FIG. 2 and FIG. 3, in one embodiment, a gas turbine-steam turbine combined power generation system based on hydrogen production by ammonia decomposition includes a liquid ammonia supply portion 101, a gasification portion 102, an ammonia decomposition portion, a gas turbine power generation set 108, a steam turbine portion and a first steam extraction pipeline 117.

The liquid ammonia input of the gasification portion 102 is connected with the liquid ammonia supply portion 101 for gasifying the liquid ammonia into gaseous ammonia. The input of the ammonia decomposition portion is connected with the gaseous ammonia output of the gasification portion 102 for decomposing the gaseous ammonia into a hydrogen-mixed gas containing hydrogen, nitrogen and gaseous ammonia. The fuel input of the gas-turbine power generation set 108 is connected with the output of the ammonia decomposition portion for combusting hydrogen-mixed gas to generate power.

Wherein, the input of the first steam extraction pipeline 117 is connected with the steam turbine portion. The output of the first steam extraction pipeline 117 is connected with the heat-source input of the gasification portion 102 for extracting the steam in the steam turbine portion and outputting it as a heat source to the gasification portion 102.

In the embodiment, the liquid ammonia supply portion 101, the gasification portion 102, the ammonia decomposition portion and the gas-turbine power generation set 108 are arranged in order to implement hydrogen production by ammonia decomposition, thereby obtaining a hydrogen-mixed gas that contains hydrogen, nitrogen and gaseous ammonia and performing combustion to generate power. The steam turbine portion and the first steam extraction pipeline 117 are further arranged. The steam in the steam turbine portion is extracted by the first steam extraction pipeline 117 and outputted to the gasification portion 102 to serve as a heat source for gasifying liquid ammonia in the gasification portion 102, thereby avoiding individually arranging heating equipment and solving the problem that the gasification device needs to be equipped with individual heating equipment in the existing hydrogen production by ammonia decomposition.

The specific structure of the gas turbine-steam turbine combined power generation system based on hydrogen production by ammonia decomposition in the embodiment will be further described as follows:

In the embodiment, the steam turbine portion specifically includes a boiler feed water device 111, a waste heat boiler 110, a steam-turbine power generation set 112 and a first water return pipeline 118.

Wherein, the output of the boiler feed water device 111 is connected with the feed water input of the waste heat boiler 110. The steam output of the waste heat boiler 110 is connected with the steam input of the steam-turbine power generation set 112. The condensed water output of the steam-turbine power generation set 112 is connected with the input of the boiler feed water device 111.

The input of the foregoing first steam extraction pipeline 117 is connected with the steam-turbine power generation set 112 for extracting low-temperature steam. The input of the first water return pipeline 118 is connected with the condensed water output of the gasification portion 102. The output of the first water return pipeline 118 is connected with the input of the boiler feed water device 111. Using a water pump on the first water return pipeline 118, the condensed water is delivered back to the boiler feed water device 111.

By arranging the steam turbine portion that contains a boiler feed water device 111, a waste heat boiler 110, a steam-turbine power generation set 112 and a first water return pipeline 118, the boiler feed water device 111 supplies water to the waste heat boiler 110 to generate steam and outputs it to the steam-turbine power generation set 112 for power generation. The first steam extraction pipeline 117 extracts low-temperature steam from the steam-turbine power generation set 112 (such as a middle-pressure cylinder or a low-pressure cylinder) and outputs it to the gasification portion 102 to gasify the liquid ammonia. The first water return pipeline 118 is further arranged for delivering the condensed water formed in the gasification process back to the boiler feed water device 111 to implement circulation.

In the embodiment, the gas turbine-steam turbine combined power generation system further includes a hydrogen storage portion arranged between the ammonia decomposition portion and the gas-turbine power generation set 108. The input and the output of the hydrogen storage portion are respectively connected with the output of the ammonia decomposition portion and the fuel input of the gas-turbine power generation set 108.

Specifically, the hydrogen storage portion may include a hydrogen storage surge tank 107 and a compressor 106. The input of the hydrogen storage surge tank 107 is connected with the output of the ammonia decomposition portion through a hydrogen-mixed gas pipeline. The output of the hydrogen storage surge tank 107 is connected with the fuel input of the gas-turbine power generation set 108 for stabilizing the output pressure of the hydrogen-mixed gas. The compressor 106 is arranged on the hydrogen-mixed gas pipeline.

Wherein, the hydrogen storage surge tank 107 is arranged on a pipeline where the mixed gas is delivered to the gas-turbine power generation set 108 and used to store the mixed gas produced by ammonia decomposition and deliver the mixed gas to the gas-turbine power generation set 108. The gas in the hydrogen storage surge tank 107 has a certain pressure, which must be greater than the minimum pressure required for the gas-turbine power generation set 108 and less than the pressure of the mixed gas produced by ammonia decomposition or the pressure at the outlet of the compressor 106.

At the same time, the hydrogen storage surge tank 107 also has the function of temporarily storing the mixed gas and replenishing the mixed gas to the gas-turbine power generation set 108 for a short time. The temporary storage is explained as follows: After completely starting the gas-turbine power generation set 108, the gas and its pressure in the hydrogen storage surge tank 107 decrease. The mixed gas produced by ammonia decomposition firstly enters the hydrogen storage surge tank 107, and then the hydrogen storage surge tank 107 supplies the mixed gas to the gas-turbine power generation set 108. When the decomposition amount of ammonia exceeds the usage amount of the gas-turbine power generation set 108, the excess mixed gas will be stored in the tank. The maximum pressure of the stored mixed gas produced by ammonia decomposition or the pressure at the outlet of the compressor 106 is less than or equal to the pressure in the tank. The short-term replenishment is explained as follows: If the decomposition amount of ammonia is lower than the usage amount of the gas-turbine power generation set 108, the gas-turbine power generation set 108 can use the mixed gas stored in the hydrogen storage surge tank 1077 for a short time until the pressure in the tank is less than the minimum mixed gas pressure required for the gas-turbine power generation set 108.

In the embodiment, the ammonia decomposition portion may include a gaseous ammonia pipeline, a hydrogen-mixed gas pipeline, an ammonia decomposition device 104 and a gaseous ammonia preheating heat exchanger 103.

The two ends of the gaseous ammonia pipeline are connected with the output of the gasification portion 102 and the gaseous ammonia input of the ammonia decomposition device 104 respectively. The two ends of the hydrogen-mixed gas pipeline are connected with the hydrogen-mixed gas output of the ammonia decomposition device 104 and the fuel input of the gas-turbine power generation set 108 respectively. Wherein, the gaseous ammonia pipeline is connected with the cold end of the gaseous ammonia preheating heat exchanger 103, and the hydrogen-mixed gas pipeline is connected with the hot end of the gaseous ammonia preheating heat exchanger 103.

The ammonia decomposition portion is divided into a gaseous ammonia pipeline, a hydrogen-mixed gas pipeline, an ammonia decomposition device 104, and a gaseous ammonia preheating heat exchanger 103. The gaseous ammonia pipeline and the hydrogen-mixed gas pipeline are respectively used as the input and the output of the ammonia decomposition device 104. By arranging the gaseous ammonia preheating heat exchanger 103, the gaseous ammonia in the gaseous ammonia pipeline can couple the hydrogen-mixed gas in the hydrogen-mixed gas pipeline for heat exchange, absorb the heat in the hydrogen-mixed gas to preheat the gaseous ammonia, and improve the energy utilization rate.

The ammonia decomposition portion also includes a hydrogen-mixed gas cooling heat exchanger 105. The hydrogen-mixed gas pipeline is connected with the hot end of the hydrogen-mixed gas cooling heat exchanger 105. The cold end of the hydrogen-mixed gas cooling heat exchanger 105 is connected with the first water return pipeline 118 for cooling the hydrogen-mixed gas by the condensed water in the gasification portion 102. Wherein, the hydrogen-mixed gas cooling heat exchanger 105 is located on the downstream of the gaseous ammonia preheating heat exchanger 103.

By arranging the hydrogen-mixed gas cooling heat exchanger 105, the cold end and the hot end of the hydrogen-mixed gas cooling heat exchanger 105 are respectively connected with the first water return pipeline 118 and the hydrogen-mixed gas pipeline. The condensed water formed in the gasification portion 102 is used to cool the hydrogen-mixed gas formed by the ammonia decomposition reaction, so that there is no need to cool the hydrogen-mixed gas again.

In the embodiment, a gaseous ammonia pressure regulating valve 115 is arranged on the gaseous ammonia pipeline. A liquid ammonia flow valve 114 is arranged on a pipeline connecting the liquid ammonia supply portion 101 with the gasification portion 102. A hydrogen-mixed gas flow valve 116 is arranged on a pipeline connecting the ammonia decomposition portion with the gas-turbine power generation set 108. By arranging the liquid ammonia flow valve 114, the gaseous ammonia pressure regulating valve 115 and the hydrogen-mixed gas flow valve 116, the supply amount of liquid ammonia, the pressure of gaseous ammonia and the output amount of hydrogen-mixed gas are respectively controlled, thereby controlling the operating state of the power generation system.

In the embodiment, the liquid ammonia supply portion 101 can be a liquid ammonia tank, and the gasification portion 102 can be a gasification device.

The principle of hydrogen production by ammonia decomposition in the embodiment will be described as follows:

The principle of hydrogen production by ammonia decomposition is that gaseous ammonia will be decomposed under the action of a catalyst at a certain temperature. That is to say, 2NH₃═N₂+3H₂. It can be seen that when the ammonia decomposition rate reaches 50%, the volume fraction of hydrogen in the mixture of hydrogen, nitrogen and gaseous ammonia is 50%. The higher the ammonia decomposition rate, the higher the content of hydrogen. Hydrogen easily ignites (e.g., the minimum ignition energy of 0.019 mJ), and has a wide flammable range (e.g., 4%˜75% compared to air volume). Hydrogen is ignited and combusted, and the combustion temperature of hydrogen is relatively high (generally higher than 1000° C.). The combustion temperature of hydrogen is much higher than the ignition point (i.e., 651.1° C.) of ammonia. Thus, ammonia will also be combusted. Accordingly, the gas-turbine power generation set 108 can directly combust the hydrogen-mixed gas.

However, the type of the catalyst in the hydrogen production process based on ammonia decomposition in the embodiment can also be selected according to the gas-turbine exhaust temperature or the temperature after supplementary combustion. The selected type of the catalyst can be adapted to low temperature and high temperature, such as Ru, Fe, Ni, etc. The ammonia decomposition rate can be improved by adjusting the catalyst or the reaction temperature (that is, increasing the gas-turbine exhaust temperature or the supplementary combustion amount).

### Embodiment 4

Referring to FIG. 3, the embodiment is further improved based on embodiment 3. A gas turbine-steam turbine combined power generation system may further include a first steam exhaust pipeline 119 and a second steam exhaust pipeline 120.

The input of the first steam exhaust pipeline 119 is connected with the exhaust end of the gas-turbine power generation set 108. The output of the first steam exhaust pipeline 119 is connected with the heat-source input of the ammonia decomposition device 104 for outputting the gas-turbine exhaust gas of the gas-turbine power generation set 108 as a heat source to the ammonia decomposition device 104. The input of the second steam exhaust pipeline 120 is connected with the heat-source output of the ammonia decomposition device 104. The output of the second steam exhaust pipeline 120 is connected with the exhaust input of the waste heat boiler 110 for outputting the gas-turbine exhaust gas utilized by the waste heat of the ammonia decomposition device 104 to the waste heat boiler 110 for waste heat utilization. Water is heated in the waste heat boiler 110.

In the embodiment, the first steam exhaust pipeline 119 and the second steam exhaust pipeline 120 are arranged. The first steam exhaust pipeline 119 outputs the gas-turbine exhaust gas of the gas-turbine power generation set 108 to the ammonia decomposition device 104, which provides the heat source required for the ammonia decomposition reaction. The second steam exhaust pipeline 120 outputs the gas-turbine exhaust gas utilized by the waste heat of the ammonia decomposition device 104 to the exhaust input of the waste heat boiler 110, so that the waste heat boiler 110 can perform secondary utilization on the waste heat of a part of the gas-turbine exhaust gas, thereby improving the energy utilization rate of the power generation system.

Further, the gas turbine generator set 108-steam turbine combined power generation system can also include a supplementary combustion device 109. The fuel input end of the supplementary combustion device 109 is connected with the output of the hydrogen storage surge tank 107. The heat-source output of the supplementary combustion device 109 is connected with the heat-source input of the ammonia decomposition device 104. The supplementary combustion device 109 is further arranged. Thus, when the reaction temperature of the gas-turbine exhaust gas is insufficient, the supplementary combustion device 109 combusts the hydrogen-mixed gas as a supplement, so as to ensure that the temperature of the ammonia decomposition reaction is within the optimal temperature range. The decomposition temperature of the ammonia decomposition reaction can be further increased, not limited to the temperature provided by the gas-turbine exhaust gas. Accordingly, the selection of catalysts is more diverse, and the ammonia decomposition rate can also be improved. By controlling the supplementary combustion amount of the supplementary combustion device 109, the ammonia decomposition temperature can be effectively controlled in a relatively stable range, thereby making the ammonia decomposition more stable. At the same time, when the gas-turbine power generation set operates under variable working conditions (such as partial-load or no-load conditions), and the gas-turbine exhaust gas is too low to provide the temperature required for ammonia decomposition, the supplementary combustion device 109 can increase the supplementary combustion amount, thereby increasing the decomposition temperature to the temperature required for the ammonia decomposition catalyst.

In the embodiment, the gas turbine generator set 108-steam turbine combined power generation system can also include a third steam exhaust pipeline 121. The input of the third steam exhaust pipeline 121 is connected with the exhaust output of the waste heat boiler 110. The output of the third steam exhaust pipeline 121 is used to connect to an external heating utilization system. The third steam exhaust pipeline 121 is further arranged. The third steam exhaust pipeline 121 outputs the gas-turbine exhaust gas that has passed through the waste heat boiler 110 for secondary waste heat utilization to, for example, an external combined cycle power generation system, an external heating utilization system, or an external cooling utilization system, so as to further implement waste heat utilization and improve the energy utilization rate of the power generation system.

The control of the supplementary combustion device 109 of the embodiment will be described as follows: According to the exhaust gas temperature of the gas-turbine power generation set 108 and the supply amount of liquid ammonia, the amount of hydrogen-mixed gas entering the supplementary combustion device 109 is adjusted, thereby controlling and adjusting the decomposition reaction temperature of the ammonia decomposition device 104. Thus, the gaseous ammonia entering the ammonia decomposition device 104 can be effectively decomposed to generate the required flow of hydrogen-mixed gas.

### Embodiment 5

Referring to FIG. 3, the embodiment is further improved based on embodiment 3. A gas turbine-steam turbine combined power generation system may further include a fourth steam exhaust pipeline 122. The input of the fourth steam exhaust pipeline 122 is connected with the exhaust end of the gas-turbine power generation set 108. The output of the fourth steam exhaust pipeline 122 is connected with the exhaust input of the waste heat boiler 110 for outputting the gas-turbine exhaust gas of the gas-turbine power generation set 108 to the waste heat boiler 110 for waste heat utilization. Water is heated in the waste heat boiler 110.

Further, the gas turbine-steam turbine combined power generation system based on hydrogen production by ammonia decomposition may further include a second steam extraction pipeline 123 and a first steam return pipeline 124.

The input of the second steam extraction pipeline 123 is connected with the gas-turbine power generation set 112. The output of the second steam extraction pipeline 123 is connected with the heat-source input of the ammonia decomposition device 104 for extracting and outputting the high-temperature steam of the gas-turbine power generation set 112 as a heat source to the ammonia decomposition device 104. The input of the first steam return pipeline 124 is connected with the heat-source output of the ammonia decomposition device 104. The output of the first steam return pipeline 124 is connected with the steam input of the gas-turbine power generation set 112 for outputting steam utilized by the waste heat of the ammonia decomposition device 104 to the gas-turbine power generation set 112.

By arranging the fourth steam exhaust pipeline, the gas-turbine exhaust gas of the gas-turbine power generation set is outputted to the waste heat boiler for waste heat utilization. The second steam extraction pipeline and the first steam return pipeline are further arranged. The second steam extraction pipeline extracts the high-temperature steam from the steam-turbine power generation set (such as a high-pressure cylinder) and outputs it to the ammonia decomposition portion to serve as the heat source for ammonia decomposition reaction. The first steam return pipeline delivers steam whose heat is cooled to a certain extent and used by the ammonia decomposition portion back to the steam-turbine power generation set (such as a middle-pressure cylinder or a low-pressure cylinder) for further power generation and utilization. 1. Use high-temperature steam as a heat source and provide it to the ammonia decomposition portion. There is no need to arrange a heating device on the ammonia decomposition portion. 2. Deliver cooled steam whose heat is utilized back to the steam-turbine power generation set for further power generation, which improves the power generation efficiency of the power generation system.

### Embodiment 6

In the embodiment, based on embodiment 3, embodiment 4 or embodiment 5, the partial control process of the gas turbine-steam turbine combined power generation system is further described as follows:

I. Control of the hydrogen-mixed gas entering the gas-turbine power generation set 108: The pressure of the hydrogen-mixed gas entering the gas-turbine power generation set 108 is set by the hydrogen storage surge tank 107. The flow of the hydrogen-mixed gas entering the gas-turbine power generation set 108 is adjusted and controlled by the hydrogen-mixed flow valve 116. The pressure (pressure measuring point 101) of ammonia entering the ammonia decomposition device 104 is monitored and controlled in real time, so that the pressure data is set to the pressure (such as 7 bar) corresponding to the requirement of the gas turbine or the inlet pressure of the appropriate hydrogen compressor.

II. Steady-state control of the hydrogen storage surge tank 107: 1) When the gas-turbine power generation set 108 starts or operates, the hydrogen-mixed gas in the hydrogen storage surge tank 107 is consumed, and the pressure in the tank will decrease. When the pressure in the tank drops to a certain value, the liquid ammonia flow valve 114 is interlocked and opened to control the flow of liquid ammonia according to the amount of the hydrogen-mixed gas required for the gas-turbine power generation set 108 in operation, so that the flow of the hydrogen-mixed gas produced by the ammonia decomposition device 104 meets the current requirement of the gas-turbine power generation set 108 in an operation state. The mixed gas pressure (pressure measuring point 102) of the hydrogen storage surge tank 107 is monitored and controlled in real time, so that the pressure data is controlled within a certain range (the outlet air pressure of the gas-turbine compressor +(˜2-10 bar)), and the high/low pressure alarm and interlock design at pressure measuring point 102 are set. When the pressure of pressure measuring point 102 is high, the compressor 106 and the liquid ammonia supply portion 101 stop working. When the pressure of pressure measuring point 102 is low, the liquid ammonia supply portion 101 and the compressor 106 start working.

2) When the amount of hydrogen-mixed gas produced by the ammonia decomposition device 104 is greater than the combustion amount of hydrogen-mixed gas of the gas-turbine power generation set 108, the excess hydrogen-mixed gas is temporarily stored in the hydrogen storage surge tank 107, the maximum pressure stored in the tank is equal to the pressure of the hydrogen-mixed gas in the ammonia decomposition device 104 or the compressed pressure of the compressor 106, and the flow of liquid ammonia from the liquid ammonia supply part 101 to the gasification portion 2 is reduced, so that the amount of hydrogen-mixed gas generated is reduced to balance with the combustion amount of hydrogen-mixed gas. The method can be specifically applied to a state where the gas-turbine power generation set 108 needs to reduce the power generation state, such as a partial-load or no-load state, etc.

3) When the amount of hydrogen-mixed gas produced by the ammonia decomposition device 104 is less than the combustion amount of hydrogen-mixed gas of the gas-turbine power generation set 108, the hydrogen-mixed gas temporarily stored in the hydrogen storage surge tank 107 is delivered to the gas-turbine power generation set 108 and used as a supplement to the amount of the hydrogen-mixed gas of the gas-turbine power generation set 108 until the pressure in the tank is equal to the minimum pressure of hydrogen-mixed gas required for the gas-turbine power generation set 108. The liquid ammonia flow valve 114 is opened and interlocked to control the flow of liquid ammonia according to the setting value of pressure in the tank, and the flow of liquid ammonia from the liquid ammonia supply part 101 to the gasification portion 2 is controlled to increase, so that the amount of hydrogen-mixed gas generated is increased to balance with the combustion amount of hydrogen-mixed gas. The method can be specifically applied to a state where the gas-turbine power generation set 108 needs to increase the power generation state, such as a non-full-load state to a full-load state, etc.

4) Pressure setting of hydrogen storage surge tank 107: greater than the minimum requirement pressure and less than the maximum setting pressure in the tank.

Further, according to the real-time monitored gas-turbine exhaust temperature (temperature measuring point 101) of the gas-turbine power generation set 108 and the type of ammonia decomposition catalyst used, the amount of hydrogen-mixed gas entering the supplementary combustion device 109 can be adjusted so that the data of temperature measuring point 101 matches the temperature required for the selected ammonia decomposition catalyst. As a result, the decomposition reaction temperature of the ammonia decomposition device 104 is controlled and adjusted, so that the gaseous ammonia entering the ammonia decomposition device 104 can be effectively decomposed to produce the required flow of hydrogen-mixed gas. The inlet water temperature of the gasifier 102 (temperature measuring point 102) is monitored and controlled in real time, so that the temperature data is controlled at about 50˜70° C. and the liquid ammonia entering the gasifier 102 can be effectively gasified and maintained at a certain superheating state.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

1. A power generation system based on hydrogen production by ammonia decomposition, comprising:
a liquid ammonia supply portion;
a gasification portion with an input thereof connected with the liquid ammonia supply portion for gasifying liquid ammonia into gaseous ammonia;
an ammonia decomposition portion with an input thereof connected with an output of the gasification portion for decomposing gaseous ammonia into a hydrogen-mixed gas containing hydrogen, nitrogen and gaseous ammonia;
a hydrogen storage portion with an input thereof connected with an output of the ammonia decomposition portion for storing and stably outputting the hydrogen-mixed gas; and
a gas-turbine power generation set with a fuel input thereof connected with an output of the hydrogen storage portion for combusting the hydrogen-mixed gas to generate power; wherein
in a power generation state, liquid ammonia outputted by the liquid ammonia supply portion is gasified into gaseous ammonia by the gasification portion and outputted to the ammonia decomposition portion, the ammonia decomposition portion decomposes the gaseous ammonia into a hydrogen-mixed gas containing hydrogen, nitrogen and gaseous ammonia, the hydrogen-mixed gas is outputted to the hydrogen storage portion for storage, and the hydrogen storage portion outputs the hydrogen-mixed gas to the gas-turbine power generation set for combustion and power generation.

2. The power generation system based on hydrogen production by ammonia decomposition according to claim 1, wherein the hydrogen storage portion comprises a hydrogen storage surge tank and a compressor;
an input of the hydrogen storage surge tank is connected with an output of the ammonia decomposition portion through a hydrogen-mixed gas pipeline, and an output of the hydrogen storage surge tank is connected with a fuel input of the gas-turbine power generation set for stabilizing output pressure of the hydrogen-mixed gas;
the compressor is arranged on the hydrogen-mixed gas pipeline.

3. The power generation system based on hydrogen production by ammonia decomposition according to claim 1, wherein an exhaust end of the gas-turbine power generation set is connected with a heat-source input of the ammonia decomposition portion, so that gas-turbine exhaust gas provides a heat source for ammonia decomposition.

4. The power generation system based on hydrogen production by ammonia decomposition according to claim 3, further comprising a heat regenerator;
a heat-source output of the ammonia decomposition portion is connected with a heat-source input of the heat regenerator, and a compressed-air output of the heat regenerator is connected with a compressed-air input of the gas-turbine power generation set for preheating compressed air for the gas-turbine power generation set.

5. The power generation system based on hydrogen production by ammonia decomposition according to claim 1, further comprising a supplementary combustion device;
a fuel input of the supplementary combustion device is connected with an output of the hydrogen storage portion, and a heat-source output of the supplementary combustion device is connected with a heat-source input of the ammonia decomposition portion.

6. The power generation system based on hydrogen production by ammonia decomposition according to claim 1, wherein the gasification portion comprises a gasifier and a medium circulation pipeline;
two ends of the gasifier are respectively connected with an output of the liquid ammonia supply portion and an input of the ammonia decomposition portion;
the medium circulation pipeline is coupled with gas-turbine exhaust gas of the gas-turbine power generation set for heat exchange through a circulating medium heat exchanger, and head and tail ends of the medium circulation pipeline are respectively connected with a medium input and a medium output of the gasifier for heating liquid ammonia in a water bath.

7. The power generation system based on hydrogen production by ammonia decomposition according to claim 6, wherein the medium circulation pipeline comprises a water tank, a pump, a temperature control valve, and an input pipeline, an intermediate pipeline and an output pipeline sequentially connected;
an input of the input pipeline is connected with a medium output of the gasifier;
an output of the output pipeline is connected with a medium input of the gasifier;
the water tank and the pump are arranged on the input pipeline;
the temperature control valve is arranged between the intermediate pipeline and the output pipeline;
wherein the intermediate pipeline and the hydrogen-mixed gas produced by the ammonia decomposition device are coupled to exchange heat through a hydrogen-mixed gas cooling heat exchanger for absorbing heat of the hydrogen-mixed gas; and an output of the intermediate pipeline is connected and coupled with the temperature control valve for heat exchange through the circulating medium heat exchanger and/or an output of the intermediate pipeline is directly connected with the temperature control valve.

8. The power generation system based on hydrogen production by ammonia decomposition according to claim 1, wherein the ammonia decomposition portion comprises a gaseous ammonia pipeline, a hydrogen-mixed gas pipeline, an ammonia decomposition device, and a gaseous ammonia preheating heat exchanger;
two ends of the gaseous ammonia pipeline are respectively connected with an output of the gasification portion and a gaseous ammonia input of the ammonia decomposition device;
two ends of the hydrogen-mixed gas pipeline are respectively connected with a hydrogen-mixed gas output of the ammonia decomposition device and an input of the hydrogen storage portion;
wherein the gaseous ammonia pipeline is connected with a cold end of the gaseous ammonia preheating heat exchanger, and the hydrogen-mixed gas pipeline is connected with a hot end of the gaseous ammonia preheating heat exchanger.

9. The power generation system based on hydrogen production by ammonia decomposition according to claim 8, wherein the ammonia decomposition portion further comprises a hydrogen-mixed gas cooling heat exchanger;
the hydrogen-mixed gas pipeline is connected with a hot end of the hydrogen-mixed gas cooling heat exchanger;
a cold end of the hydrogen-mixed gas cooling heat exchanger is connected with a medium circulation pipeline of the gasification portion;
wherein, the hydrogen-mixed gas cooling heat exchanger is located on downstream of the gaseous ammonia preheating heat exchanger.

10. A method for dynamically adjusting the power generation system based on hydrogen production by ammonia decomposition according to claim 1, the power generation system further comprising a supplementary combustion device, a fuel input of the supplementary combustion device connected with an output of the hydrogen storage portion, a heat-source output of the supplementary combustion device connected with a heat-source input of the ammonia decomposition portion, and the method comprising:
according to a gas-turbine exhaust temperature of the gas-turbine power generation set and supply amount of liquid ammonia, amount of hydrogen-mixed gas entering the supplementary combustion device is adjusted to control and adjust a decomposition reaction temperature of the ammonia decomposition portion, so that ammonia entering the ammonia decomposition portion is effectively decomposed to produce a desired flow of the hydrogen-mixed gas.

11. A gas turbine-steam turbine combined power generation system based on hydrogen production by ammonia decomposition, comprising:
a liquid ammonia supply portion;
a gasification portion with an input thereof connected with the liquid ammonia supply portion for gasifying liquid ammonia into gaseous ammonia;
an ammonia decomposition portion with an input thereof connected with an output of the gasification portion for decomposing gaseous ammonia into a hydrogen-mixed gas containing hydrogen, nitrogen and gaseous ammonia;
a gas-turbine power generation set with a fuel input thereof connected with an output of the ammonia decomposition portion for combusting the hydrogen-mixed gas to generate power;
a steam turbine portion;
a first steam extraction pipeline with an input thereof connected with the steam turbine portion, and an output of the first steam extraction pipeline is connected with a heat-source input of the gasification portion for extracting steam as a heat source in the steam turbine portion and sending out the heat source to the gasification portion;
in a power generation state, the liquid ammonia supply portion outputs liquid ammonia to the gasification portion, the first steam extraction pipeline extracts and outputs steam in the turbine portion to the gasification portion, and the steam gasifies the liquid ammonia in the gasification portion to form gaseous ammonia; the gaseous ammonia is outputted to the ammonia decomposition portion and decomposed into a hydrogen-mixed gas containing hydrogen, nitrogen and gaseous ammonia, and the hydrogen-mixed gas is outputted to the gas-turbine power generation set for combustion and power generation.

12. The gas turbine-steam turbine combined power generation system based on hydrogen production by ammonia decomposition according to claim 11, wherein the steam turbine portion comprises a boiler feed water device, a waste heat boiler, a steam-turbine power generation set, and a first water return pipeline;
an output end of the boiler feed water device is connected with a feed water input of the waste heat boiler;
a steam output of the waste heat boiler is connected with a steam input of the steam turbine generator set;
a condensed water output of the steam-turbine power generation set is connected with an input of the boiler feed water device;
an input of the first steam extraction pipeline is connected with the steam-turbine power generation set for extracting low-temperature steam;
an input of the first water return pipeline is connected with a condensed water output of the gasification portion, and an output of the first water return pipeline is connected with an input of the boiler feed water device.

13. The gas turbine-steam turbine combined power generation system based on hydrogen production by ammonia decomposition according to claim 12, further comprising a first steam exhaust pipeline, a second steam exhaust pipeline, and a third steam exhaust pipeline;
an input of the first steam exhaust pipeline is connected with an exhaust end of the gas-turbine power generation set, and an output of the first steam exhaust pipeline is connected with a heat-source input of the ammonia decomposition portion for outputting gas-turbine exhaust gas of the gas-turbine power generation set as a heat source to the ammonia decomposition portion;
an input of the second steam exhaust pipeline is connected with a heat-source output of the ammonia decomposition portion, and an output of the second steam exhaust pipeline is connected with an exhaust input of the waste heat boiler for outputting gas-turbine exhaust gas utilized by waste heat of the ammonia decomposition portion to the waste heat boiler for waste heat utilization;
an input of the third steam exhaust pipeline is connected with an exhaust output of the waste heat boiler, and an output of the third steam exhaust pipeline is used to connect to an external heating utilization system or an external cooling utilization system.

14. The gas turbine-steam turbine combined power generation system based on hydrogen production by ammonia decomposition according to claim 13, further comprising a fourth steam exhaust pipeline with an input thereof connected with an exhaust end of the gas-turbine power generation set, and an output of the fourth steam exhaust pipeline is connected with an exhaust input of the waste heat boiler for outputting gas-turbine exhaust gas of the gas-turbine power generation set to the waste heat boiler for waste heat utilization.

15. The gas turbine-steam turbine combined power generation system based on hydrogen production by ammonia decomposition according to claim 13, further comprising a supplementary combustion device, a fuel input of the supplementary combustion device is connected with an output of the ammonia decomposition portion, and a heat-source output of the supplementary combustion device is connected with a heat-source input of the ammonia decomposition portion.

16. The gas turbine-steam turbine combined power generation system based on hydrogen production by ammonia decomposition according to claim 15, further comprising a second steam extraction pipeline and a first steam return pipeline;
an input of the second steam extraction pipeline is connected with the gas-turbine power generation set; an output of the second steam extraction pipeline is connected with a heat-source input of the ammonia decomposition portion for extracting and outputting high-temperature steam of the gas-turbine power generation set as a heat source to the ammonia decomposition portion;
an input of the first steam return pipeline is connected with a heat-source output of the ammonia decomposition portion, and an output of the first steam return pipeline is connected with a steam input of the gas-turbine power generation set for outputting steam utilized by waste heat of the ammonia decomposition portion to the gas-turbine power generation set.

17. The gas turbine-steam turbine combined power generation system based on hydrogen production by ammonia decomposition according to claim 11, wherein the ammonia decomposition portion comprises a gaseous ammonia pipeline, a hydrogen-mixed gas pipeline, an ammonia decomposition device, and a gaseous ammonia preheating heat exchanger;
two ends of the gaseous ammonia pipeline are respectively connected with an output of the gasification portion and a gaseous ammonia input of the ammonia decomposition device;
two ends of the hydrogen-mixed gas pipeline are respectively connected with a hydrogen-mixed gas output of the ammonia decomposition device and a fuel input of the gas-turbine power generation set;
wherein, the gaseous ammonia pipeline is connected with a cold end of the gaseous ammonia preheating heat exchanger, and the hydrogen-mixed gas pipeline is connected with a hot end of the gaseous ammonia preheating heat exchanger.

18. The gas turbine-steam turbine combined power generation system based on hydrogen production by ammonia decomposition according to claim 11, wherein the ammonia decomposition portion further comprises a hydrogen-mixed gas cooling heat exchanger;
the hydrogen-mixed gas pipeline is connected with a hot end of the hydrogen-mixed gas cooling heat exchanger;
a cold end of the hydrogen-mixed gas cooling heat exchanger is connected with the first water return pipeline for cooling the hydrogen-mixed gas by condensed water of the gasification portion;
wherein, the hydrogen-mixed gas cooling heat exchanger is located on downstream of the gaseous ammonia preheating heat exchanger.

19. A method for controlling the gas turbine-steam turbine combined power generation system based on hydrogen production by ammonia decomposition according to claim 11, the power generation system further comprising a hydrogen storage portion arranged between the ammonia decomposition portion and the gas-turbine power generation set, wherein
when amount of hydrogen-mixed gas produced by the ammonia decomposition portion is greater than combustion amount of hydrogen-mixed gas of the gas-turbine power generation set, excess hydrogen-mixed gas is temporarily stored in the hydrogen storage portion, and a liquid ammonia output flow of the liquid ammonia supply portion is reduced to balance supply and demand;
when amount of hydrogen-mixed gas produced by the ammonia decomposition portion is less than combustion amount of hydrogen-mixed gas of the gas-turbine power generation set, hydrogen-mixed gas temporarily stored in the hydrogen storage portion is a supplement to amount of hydrogen-mixed gas delivered to the gas turbine, and a liquid ammonia output flow of the liquid ammonia supply portion is increased to balance supply and demand.

20. The method for controlling the gas turbine-steam turbine combined power generation system according to claim 19, wherein the power generation system further comprises a supplementary combustion device, a fuel input of the supplementary combustion device is connected with an output of the hydrogen storage portion, a heat-source output of the supplementary combustion device is connected with a heat-source input of the ammonia decomposition portion, wherein
according to a gas-turbine exhaust temperature of the gas-turbine power generation set and supply amount of liquid ammonia, amount of hydrogen-mixed gas entering the supplementary combustion device is adjusted to control and adjust a decomposition reaction temperature of the ammonia decomposition portion, so that ammonia entering the ammonia decomposition portion is effectively decomposed to produce a desired flow of the hydrogen-mixed gas.
